(19) United States
(12) Patent Application Publication
(10) Pub. No.: US 2003/0074278 A1
(43) Pub. Date: Apr. 17, 2003

(54) Apparatus and method of effectuating real-time price calculations based on user preferences

(75) Inventors: Susann Marie Keohane, Austin, TX (US); Johnny Meng-Han Shieh, Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 09/975,186

(22) Filed: Oct. 11, 2001

(51) Int. Cl. G06F 17/60

(52) U.S. Cl. 705/27

(57) ABSTRACT

An apparatus and method of providing real-costs of items to an e-commerce shopper are provided. When a shopper puts a pointing device on or near an item, the real cost of the item is calculated by adding the price of the item, cost of shipping if any, sales tax if any and substracting any discount the shopper may have. If the shopper puts the pointing device on a shopping cart within which a plurality of items are located, the real costs of the items are calculated by adding the price of all the items in the cart, cost of shipping if any, sales tax if any and substracting any discount the shopper may have.

### BACKGROUND OF THE INVENTION

1. Technical Field

The present invention is directed to electronic commerce. More specifically, the present invention is directed to an apparatus and method of effectuating real-time price calculations based on user preferences.

2. Description of Related Art

As is well known by now, the World Wide Web (WWW) or Internet is a system of servers that support specially formatted documents. The documents are formatted in a script called Hyper Text Markup Language (HTML) that supports links (reference addresses) to other documents as well as graphics, audio and video files. This allows a user to jump from one document or web page to another by just one click of a mouse or any other pointing device.

In recent years, the World Wide Web has been used more and more in commerce (i.e., electronic or e-commerce). Many Web servers have been developed that allow vendors to advertise and sell products. The products may include items (e.g., software such as application programs, music) that may be delivered electronically to a purchaser over the Internet as well as items (e.g., hardware such as computer hardware, books) that are delivered through conventional distribution channels (e.g., by the Post Office, United Parcel Service etc.).

Ordinarily, an electronic version of a catalog, posted on the Internet (i.e., stored on a server computer system), provides a list of available items. A user or potential purchaser may browse through the catalog using a Web browser and select various items. Each time an item is selected, it is added into an electronic version of a shopping cart. When the user is ready to check out, the cumulative prices of the selected items are summed up. Any discount that the user may be entitled to is then computed off the sum. Then, sales tax, when applicable, and cost for shipping, if any, are added up to the cumulative price of the items to arrive at the total amount of money the user has to pay.

One of the problems associated with this e-commerce method of shopping is that the user is never aware of the total amount to pay until ready to check out. At this instant, if the total amount exceeds the user's budget, the user then has to take items off of the shopping cart until the total amount of the remaining items falls within the user's budget.

What is needed, therefore, is an apparatus and method of providing real costs of items as a user selects or points (possibly with a mouse) either at items individually or collectively (i.e., pointing at the shopping cart). Real costs, in this case, include prices of the items, cost of shipping, if any, and sales tax, where applicable, minus any discounts that may be offered.

### SUMMARY OF THE INVENTION

The present invention provides an apparatus and method of providing real-costs of items to an e-commerce shopper. When a shopper puts a pointing device on or near an item, the invention calculates the real cost of the item by adding the price of the item, cost of shipping if any, sales tax if any and substracting any discount the shopper may have. If the shopper puts the pointing device on a shopping cart within which a plurality of items are located, the invention calculates the real costs of the items by adding the price of all the items in the cart, cost of shipping if any, sales tax if any and substracting any discount the shopper may have.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a representative e-commerce store.

FIG. 5 is a first graphical user interface that may be used by the invention.

FIG. 6 is a second graphical user interface that may be used by the invention.

FIG. 7 is flow diagram of a process used by the present invention.

### DETAILED DESCRIPTION OF THE PREFERRED EMBODIMENT

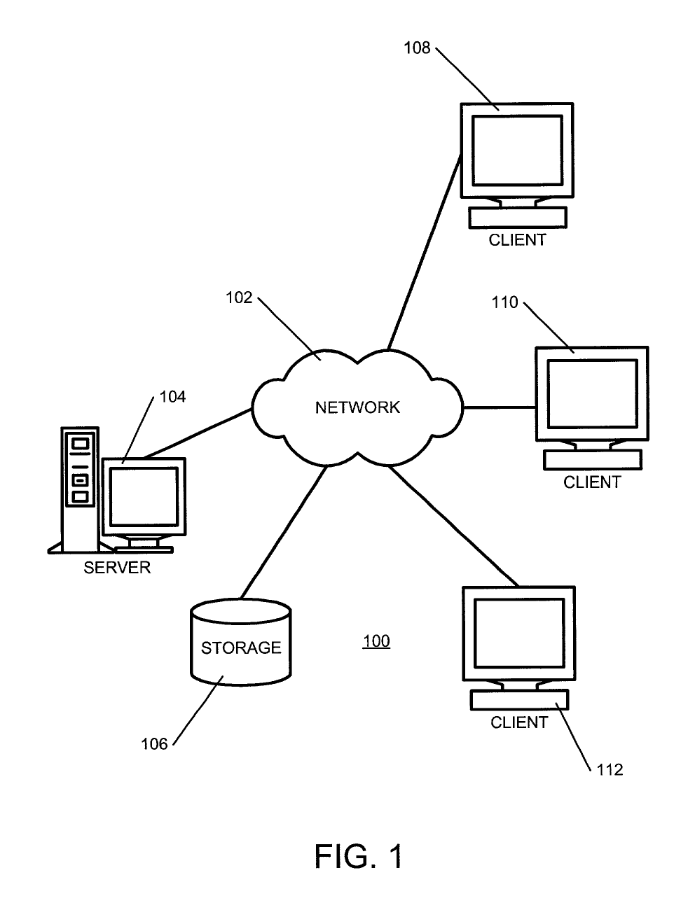

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

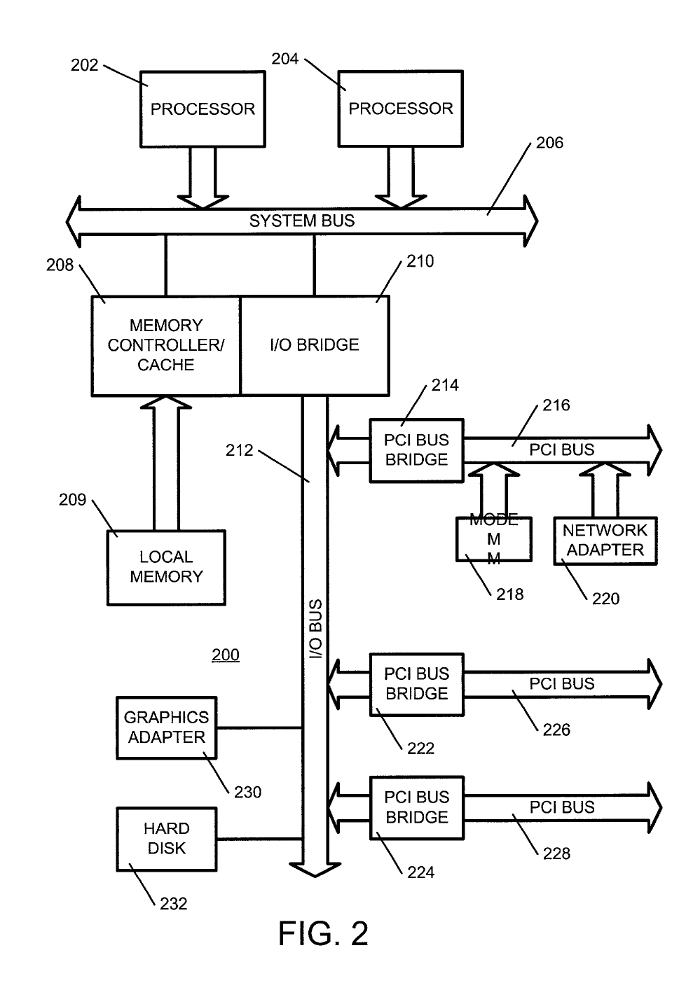

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

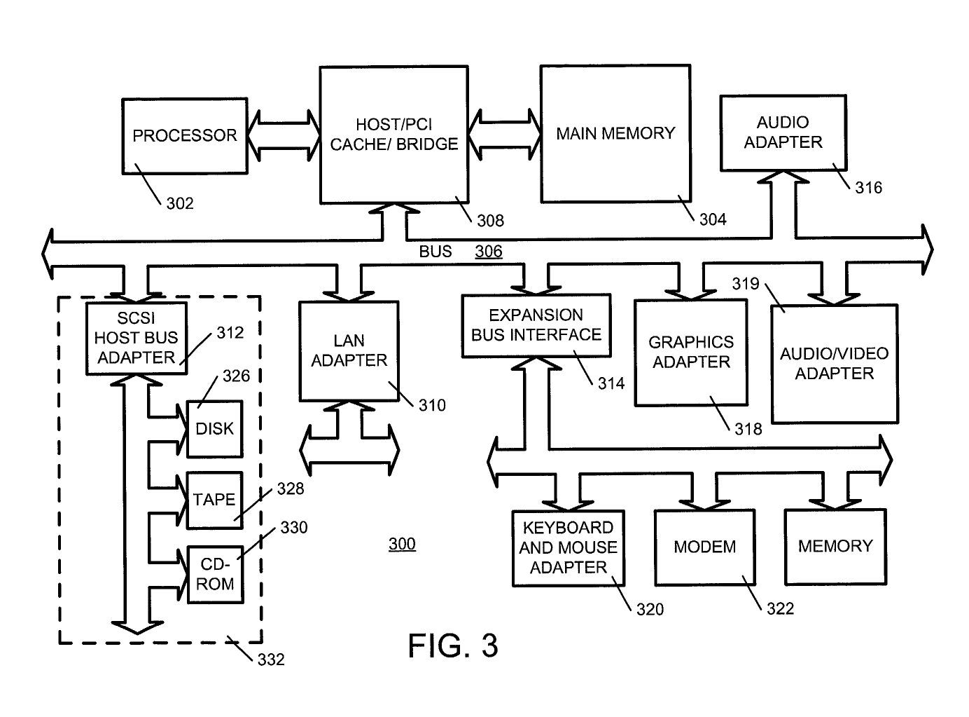

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of providing real-time calculations of items during an e-commerce transaction. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

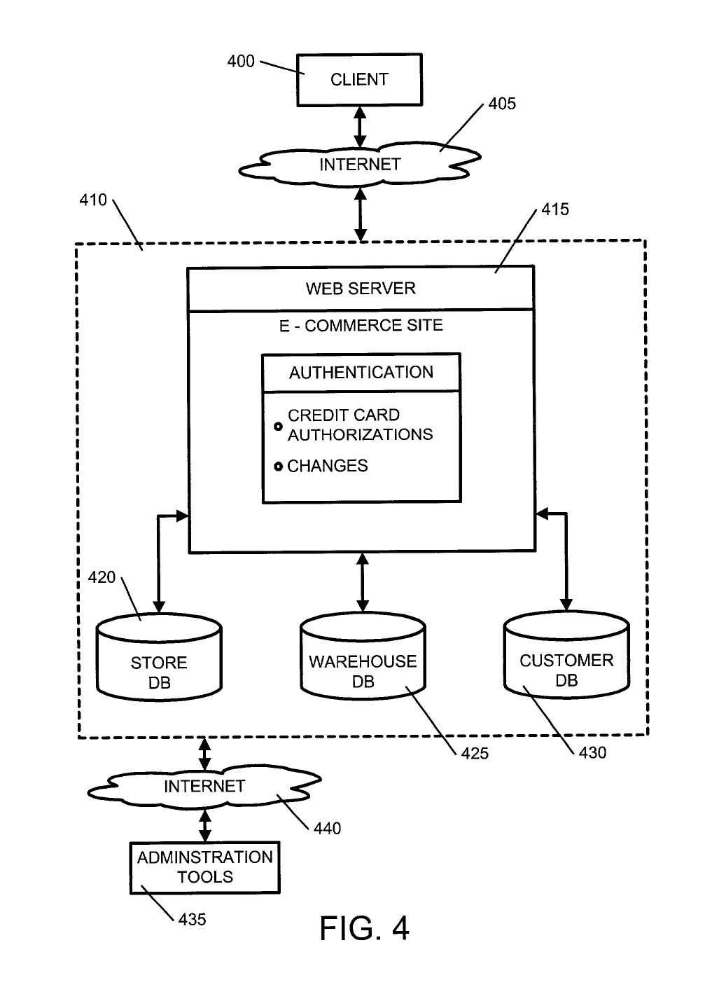

FIG. 4 is a representative e-commerce store. The virtual e-commerce store 410 comprises a Web server 415 and several databases. Store database 420 includes authorization and authentication data. Warehouse database 425 contains inventory data. Customer database 430 contains customer-specific archival data. The consumer-specific archival data includes name, age, street and shipping addresses, credit card number, membership in groups, societies that may have a business relationship with the virtual store etc.

Users or shoppers may access the virtual store by using a client system 400 having a Web browser communicating with the Web server 415 over a network 405 (e.g., the Internet, WAN, LAN). Authorization and authentication data can be transacted between an administrative tools site 435 and the store database 420 over a network 440 (e.g., Internet, WAN, LAN). Data for filling out orders can be communicated between a fulfillment center (not shown) and the warehouse database 425. The fulfillment center may arrange for purchased items to be picked up by the shoppers or delivered to the shoppers.

Items in a virtual retail store are browsed and selected as a shopper searches through the store. The store, which is itself a representation of the total inventory of products which can be purchased at a given network address, can be represented graphically or textually, or both. The nature of the graphical images may depend upon the nature of the products. The shopping list may be represented by a shopping cart into which items are placed. The shopper can use a mouse or other pointing devices to copy or drag icons of the items into the shopping cart. Alternatively, the user may click on an “add to cart” icon when an item is highlighted to add the item to the shopping cart. The shopper may have graphical means or textual means or both to locate items for purchase. A visual navigation aid or metaphor for search and selection may be provided.

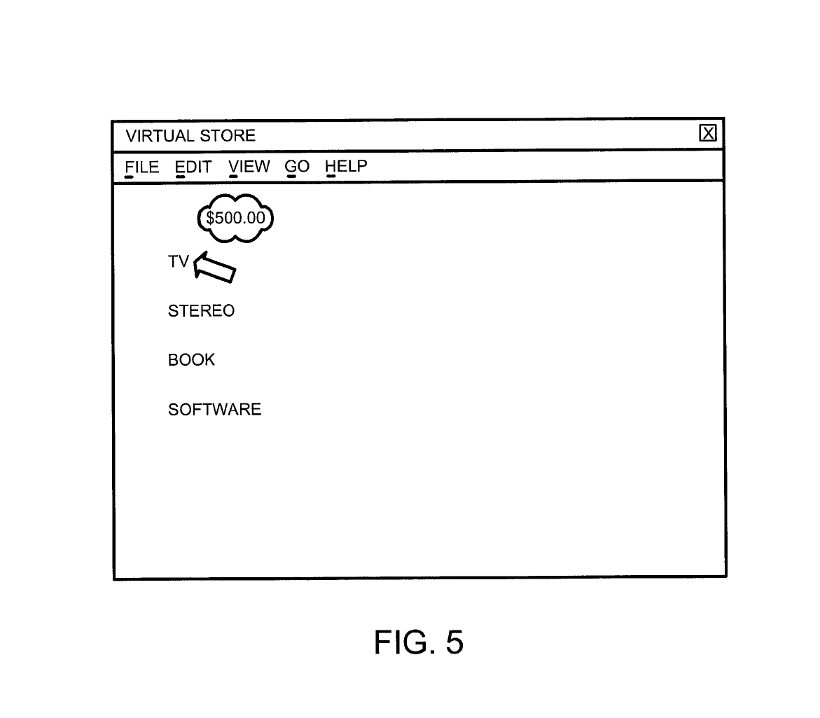

FIG. 5 is a graphical user interface that may be used by the invention. As mentioned above, with the use of a pointing device such as a mouse, a user selects and places items to be purchased in a shopping cart. When the pointing device is located on an item such as TV, the present invention calculates in real-time the true cost of the TV. That is, the price of the TV, plus sales tax if applicable, cost for shipment (based on the weight of the TV and the rate per pound charged by the most often used shipping company) are all added up. If the shopper has a discount based on affiliations with certain companies with which the virtual store has a business relationship, the discount will be subtracted from the total cost to arrive at the real cost of the object. When the real cost calculation is done, it is displayed in a bubble-like manner over the pointer as shown. In this case, the pointer is located on TV and the real-cost of the TV is displayed in a bubble as being $500.00.

In addition, certain messages may pop up when the mouse is on an item or when the shopper is attempting to put an item in the shopping cart. For example, suppose a state prohibits the sale of alcoholic beverages over the Internet. Suppose further that the shopper's mailing address is in that state. When the user puts the pointer on a bottle of alcoholic beverage or is attempting to put a bottle of alcoholic beverage into the shopping cart, a warning message may be displayed to let the shopper know that the shopper may not be sold alcoholic beverages over the Internet.

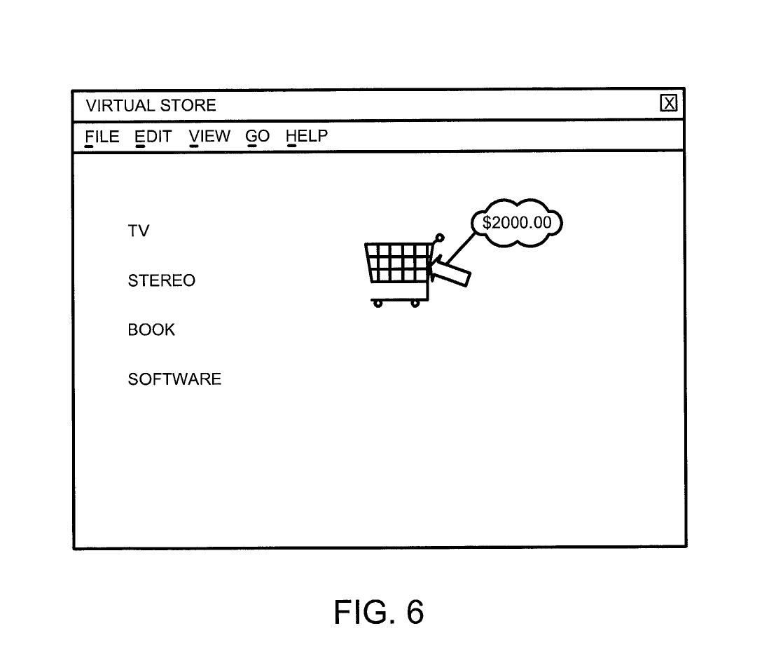

As shown in FIG. 6, if the user has placed the TV, a stereo and a book in the shopping cart and the pointer is located on or near the shopping cart, a real cost calculation of all the items in the shopping cart is effectuated and displayed. In this particular example, a real-cost of $2,000.00 is shown as being the total cost of the items in the cart. Thus, the invention allows a shopper to always know before checking out whether the real total cost of selected items is within budget.

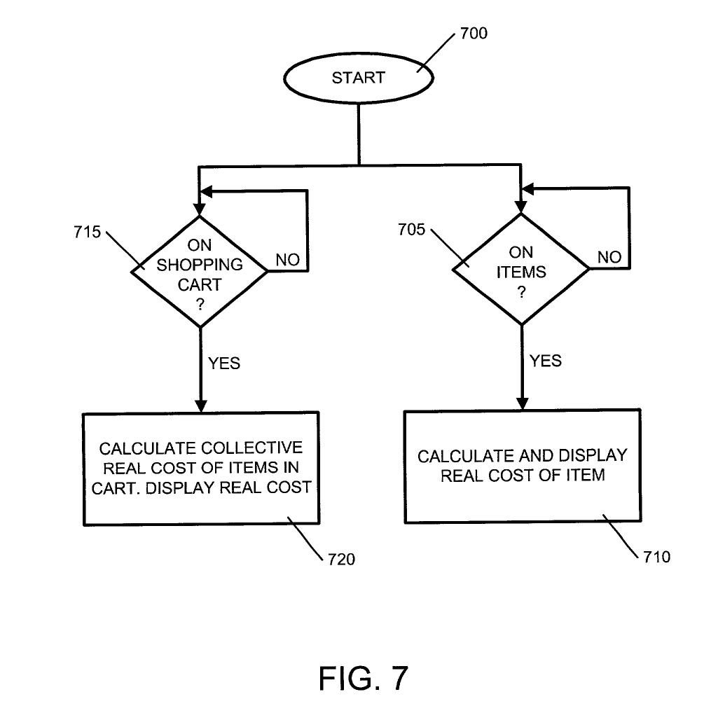

FIG. 7 is flow diagram of a process used by the present invention. The process starts as soon as a user enters or accesses the virtual store (step 700). Two checks are continuously being made. The first check is to determine whether the pointer lingers on an item. If so, the real cost of the items will be calculated and displayed or an appropriate message may be displayed (steps 705 and 710). To do the calculation of the real cost of the item, certain information must already be in the system. For example, the age or date of birth of the shopper must be known if the shopper is to be given a senior citizen discount, for instance. The home address of the shopper must also be known to determine whether sales tax is to be collected. In addition, the shipping address must be in the system in order to calculate the shipping cost of the item. The weight of the item as well as the rate charged by the most often used shipping company will have already be in the system.

If the user is a first time shopper, the user may be prompted to enter all the needed information in case the real cost of an item is ever desired. Of course, the user need not enter the information and in this case, only the price of the item will be displayed and preferably in a different color to indicate that this is not the real cost of the item. If the user is not a first time shopper, all the information would have already been collected when the user checked out the previous time. Furthermore, the user may have to register to enter the virtual store so that the store may know who the shopper is.

The second test is to determine whether the pointer is on the shopping cart. If so, the price of each item in the cart is added up. If the shopper is in a jurisdiction that requires that sales tax be paid, the sales tax will be added up to the price of the items. Shipping cost if any will be added up also. Of course, any discounts the shopper may have will be deducted off the price of the items. Once the calculation is done, the real-cost of the items in the cart will be displayed.

Note that determining whether a pointer is on or near a shopping cart or an item is well known in the field. Furthermore, doing calculations and displaying the results in a bubble over a pointer are also well known in the art. Consequently, there is not any discussion regarding these features.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of providing a cost of an item to an e-commerce shopper before the shopper checks out comprising the steps of:
calculating the cost of the item selected by the shopper; the real cost of the item including price of the item, shipping cost if any and sales tax if any; and
displaying the cost of the item.

2. The method of claim 1 wherein the step of calculating including the step of substracting any discount the shopper may have from the cost of the item.

3. The method of claim 2 wherein the shopper selects an item by putting a pointing device on or near the item.

4. The method of claim 3 wherein the step of displaying including the step of displaying a bubble within which the cost is displayed.

5. The method of claim 4 wherein the bubble is displayed above the pointing device.

6. The method of claim 2 wherein the shopper selects an item by putting the item in a shopping cart and if the shopping cart has more than one item, the step of calculating including the step of adding the price of all the items in the cart plus cost of shipping if any and sales tax if any minus any discount the shopper may have.

7. The method of claim 6 wherein the step of calculating commences when the shopper uses a pointing device on or near the cart.

8. The method of claim 7 wherein the step of displaying including the step of displaying a bubble within which the cost is displayed.

9. The method of claim 8 wherein the bubble is displayed above the pointing device.

10. A computer program product on a computer readable medium for providing a cost of an item to an e-commerce shopper before the shopper checks out comprising:
code means for calculating the cost of the item selected by the shopper; the real cost of the item including price of the item, shipping cost if any and sales tax if any; and
code means for displaying the cost of the item.

11. The computer program product of claim 10 wherein the calculating code means including code means for substracting any discount the shopper may have from the cost of the item.

12. The computer program product of claim 11 wherein the shopper selects an item by putting a pointing device on or near the item.

13. The computer program product of claim 12 wherein the displaying code means including code means for displaying a bubble within which the cost is displayed.

14. The computer program product of claim 13 wherein the bubble is displayed above the pointing device.

15. The computer program product of claim 11 wherein the shopper selects an item by putting the item in a shopping cart and if the shopping cart has more than one item, the calculating code means including code means for adding the price of all the items in the cart plus cost of shipping if any and sales tax if any minus any discount the shopper may have.

16. The computer program product of claim 15 wherein the calculating code means commences to calculate the cost when the shopper uses a pointing device on or near the cart.

17. The computer program product of claim 16 wherein the displaying code means including code means for displaying a bubble within which the cost is displayed.

18. The computer program product of claim 17 wherein the bubble is displayed above the pointing device.

19. An apparatus for providing a cost of an item to an e-commerce shopper before the shopper checks out comprising:
means for calculating the cost of the item selected by the shopper; the cost of the item including price of the item, shipping cost if any and sales tax if any; and
means for displaying the cost of the item.

20. The apparatus of claim 19 wherein the calculating means including means for substracting any discount the shopper may have from the cost of the item.

21. The apparatus of claim 20 wherein the shopper selects an item by putting a pointing device on or near the item.

22. The apparatus of claim 21 wherein the displaying means including means for displaying a bubble within which the cost is displayed.

23. The apparatus of claim 22 wherein the bubble is displayed above the pointing device.

24. The apparatus of claim 20 wherein the shopper selects an item by putting the item in a shopping cart and if the shopping cart has more than one item, the calculating means including means for adding the price of all the items in the cart plus cost of shipping if any and sales tax if any minus any discount the shopper may have.

25. The apparatus of claim 24 wherein the calculating means commences to calculate when the shopper uses a pointing device on or near the cart.

26. The apparatus of claim 25 wherein the displaying means including means for displaying a bubble within which the cost is displayed.

27. The apparatus of claim 26 wherein the bubble is displayed above the pointing device.

28. A computer system for providing a cost of an item to an e-commerce shopper before the shopper checks out comprising:
a storage device for storing code data; and
a processor for processing said code data for calculating the cost of the item selected by the shopper; the real cost of the item including price of the item, shipping cost if any and sales tax if any; and displaying the cost of the item.

29. The computer system of claim 28 wherein calculating the cost of the item includes substracting any discount the shopper may have from the cost of the item.

30. The computer system of claim 29 wherein the shopper selects an item by putting a pointing device on or near the item.

31. The computer system of claim 30 wherein displaying the cost includes displaying a bubble within which the cost is displayed.

32. The computer system of claim 31 wherein the bubble is displayed above the pointing device.

33. The computer system of claim 29 wherein the shopper selects an item by putting the item in a shopping cart and if the shopping cart has more than one item, calculating the cost includes adding the price of all the items in the cart plus cost of shipping if any and sales tax if any minus any discount the shopper may have.

34. The computer system of claim 33 wherein calculating the cost commences when the shopper uses a pointing device on or near the cart.

35. The computer system of claim 34 wherein displaying the cost includes displaying a bubble within which the cost is displayed.

36. The computer system of claim 35 wherein the bubble is displayed above the pointing device.
